(19) United States
(12) Patent Application Publication
(10) Pub. No.: US 2005/0188074 A1
(43) Pub. Date: Aug. 25, 2005

(54) System and method for self-configuring and adaptive offload card architecture for TCP/IP and specialized protocols

(76) Inventors: Kaladhar Voruganti, San Jose, CA (US); Sandeep Madhav Uttamchandani, San Jose, CA (US); Piyush Shivam, Raleigh, NC (US)

Correspondence Address: Mark C. McCabe;IBM Corporation, Intellectual Property Law, 650 Harry Road, Dept. C4TA/J2B, San Jose, CA, 95120-6099, US

(21) Appl. No.: 10/754,778

(22) Filed: Jan. 9, 2004

(51) Int. Cl. G06F 15/173

(52) U.S. Cl. 709/224; 709/226

(57) ABSTRACT

An intelligent offload engine to configure protocol processing between a host and the intelligent offload engine in order to improve optimization of protocol processing is provided. The intelligent offload engine provides for evaluating the host and the host environment to identify system parameters associated with the host and a host bus adapter card, wherein the intelligent offload engine exists at the host bus adapter card. Also, the intelligent offload engine determines the ability of the host and the intelligent offload engine to perform protocol processing according to the identified system parameters. In addition, the intelligent offload engine determines an optimal protocol processing configuration between the host and the intelligent offload engine, according to the determined ability of the host to perform protocol processing and the intelligent offload engine ability to perform protocol processing. Moreover, the intelligent offload engine implements the determined optimal protocol processing configuration.

### FIELD OF THE INVENTION

The present invention relates to the field of IP Storage protocol processing and, more specifically, to a method and product for providing an intelligent protocol processing configuration between a host and a network interface card (NIC)/host bust adapter card (HBA).

### BACKGROUND

Hardware protocol offloading has been proposed as the “Silver Bullet” for improving system performance. Experimental results using micro and macro benchmarks demonstrate that offloading may or may not help (and possibly even degrade performance) depending on the system configuration and the workload characteristics.

Hardware offloading proves beneficial in several cases. Hardware offloading is beneficial because it reduces absolute pathlength by virtue of interrupt coalescing and zero-copy. This allows for a slower NIC/HBA to execute the reduced pathlength, which is equivalent to a faster host CPU executing the original pathlength. Hardware offloading also improves performance when the application is communication intensive and the host CPU is a bottleneck, by allocating more cycles of the host CPU for application processing. Also, with the advent of 10 Gbps network speeds, the host CPU by itself might not be able to handle the network speeds, hence hardware offloading may be helpful. This is true since the network speeds are increasing at a faster rate compared to the CPU speeds.

In contrast, hardware offloading is non-beneficial (in some cases detrimental) because processor speeds on the host are increasing at a much faster rate compared to that of the offload card. Offloading can degrade performance in scenarios where the protocol processing is moved from a much faster host to a slower offload card that eventually becomes a bottleneck.

In the case of applications that are compute intensive, hardware offloading does not have any significant impact on performance.

When the host CPU speed is fast enough to support application processing at network speed, offloading does not improve performance.

Thus, there is no single offload solution that is a “one size fit all” i.e. for variations in system configurations and workload characteristics. Existing architectures for offloading are not robust enough with respect to performance.

### SUMMARY OF THE INVENTION

According to the present invention, there is provided a method of configuring protocol processing between a host and an intelligent offload engine in order to improve optimization of protocol processing. The method includes evaluating the host and the host environment to identify system parameters associated with the host and a host bus adapter card, wherein the intelligent offload engine exists at the host bus adapter card. Also, the method includes determining the ability of the host and the intelligent offload engine to perform protocol processing according to the identified system parameters. In addition, the method includes determining an optimal protocol processing configuration between the host and the intelligent offload engine, according to the determined ability of the host to perform protocol processing and the intelligent offload engine ability to perform protocol processing. Moreover, the method includes implementing the determined optimal protocol processing configuration.

### BRIEF DESCRIPTION OF THE DRAWINGS

FIG. 1 shows a tiered overview of a SAN connecting multiple servers to multiple storage systems.

FIG. 2 illustrates an IP Storage system, in which SCSI over IP (iSCSI) is utilized to enable general purpose storage applications to run over TCP/IP.

FIG. 3 illustrates a block diagram of a host server including intelligent offload engine (IOE), according to an exemplary embodiment of the invention.

FIG. 4 is a block diagram of an intelligent offload engine (IOE), according to an exemplary embodiment of the invention.

FIG. 5 illustrates a method of determining and configuring an initial protocol processing configuration between a host server and an intelligent offload engine (IOE), according to an exemplary embodiment of the invention.

FIG. 6 illustrates a method of adaptively configuring the protocol processing configuration between a host server and an intelligent offload engine (IOE), according to an exemplary embodiment of the invention.

FIG. 7 illustrates a method of handling protocol processing for messages leaving a host server in which an intelligent offload engine (IOE) is utilized, according to an exemplary embodiment of the invention.

FIG. 8 illustrates a method of handling protocol processing for messages entering a host server via an HBA/NIC associated with the host server, in which an intelligent offload engine (IOE) at the HBA/NIC is utilized, according to an exemplary embodiment of the invention.

### DETAILED DESCRIPTION

The invention will be described primarily as a method and intelligent offload engine (IOE) product for configuring protocol processing (e.g., TCP/IP, iSCSI, etc.) between a host and the IOE, in order to provide optimal protocol processing. In the following description, for purposes of explanation, numerous specific details are set forth in order to provide a thorough understanding of the present invention. It will be evident, however, to one skilled in the art that the present invention may be practiced without these specific details.

Those skilled in the art will recognize that an apparatus, such as a data processing system, including a CPU, memory, I/O, program storage, a connecting bus and other appropriate components could be programmed or otherwise designed to facilitate the practice of the invention. Such a system would include appropriate program means for executing the operations of the invention.

An article of manufacture, such as a pre-recorded disk or other similar computer program product for use with a data processing system, could include a storage medium and program means recorded thereon for directing the data processing system to facilitate the practice of the method of the invention. Moreover, the invention can be implemented with a network processor and firmware, specialized ASICs, or a combination of both. Such apparatus and articles of manufacture also fall within the spirit and scope of the invention.

SANs

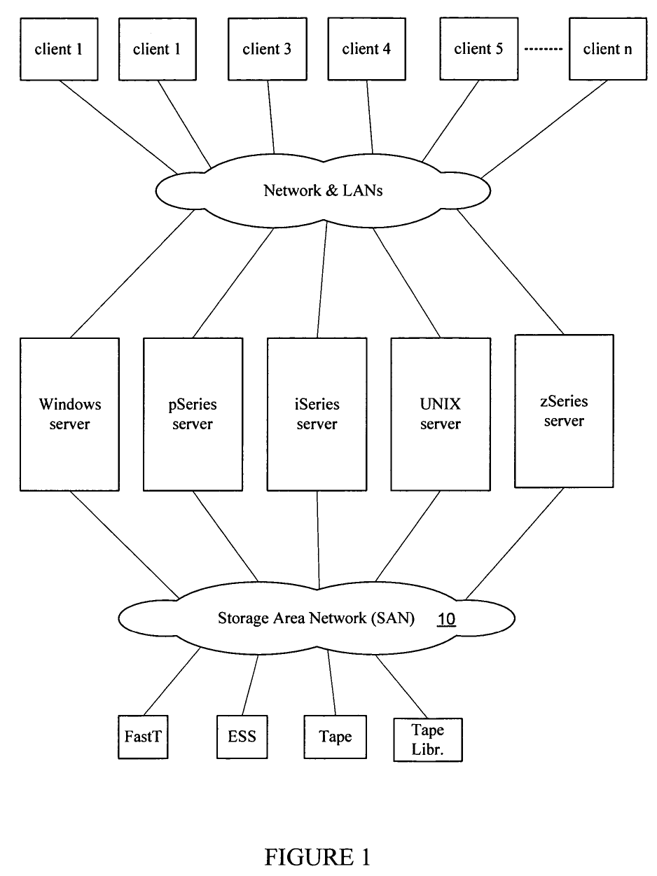

FIG. 1 shows a tiered overview of a SAN 10 connecting multiple servers to multiple storage systems. There has long been a recognized split between presentation, processing, and data storage. Client/server architecture is based on this three tiered model. In this approach, computer network can be divided into tiers: The top tier uses the desktop for data presentation. The desktop is usually based on Personal Computers (PC). The middle tier, application servers, does the processing. Application servers are accessed by the desktop and use data stored on the bottom tier. The bottom tier consists of storage devices containing the data.

In SAN 10, the storage devices in the bottom tier are centralized and interconnected, which represents, in effect, a move back to the central storage model of the host or mainframe. A SAN is a high-speed network that allows the establishment of direct connections between storage devices and processors (servers) within the distance supported by the SAN fabric (e.g., Ethernet, Fibre Channel). The SAN can be viewed as an extension to the storage bus concept, which enables storage devices and servers to be interconnected using similar elements as in local area networks (LANs) and wide area networks (WANs): routers, hubs switches, directors, and gateways. A SAN can be shared between servers and/or dedicated to one server. It can be local, or can be extended over geographical distances.

SANs such as SAN 10 create new methods of attaching storage to servers. These new methods can enable great improvements in both availability and performance. SAN 10 is used to connect shared storage arrays and tape libraries to multiple servers, and are used by clustered servers for failover. They can interconnect mainframe disk or tape to mainframe servers where the SAN devices allow the intermixing of open systems (such as Windows, AIX) and mainframe traffic.

SAN 10 can be used to bypass traditional network bottlenecks. It facilitates direct, high speed data transfers between servers and storage devices, potentially in any of the following three ways: Server to storage: This is the traditional model of interaction with storage devices. The advantage is that the same storage device may be accessed serially or concurrently by multiple servers. Server to server: A SAN may be used for high-speed, high-volume communications between servers. Storage to storage: This outboard data movement capability enables data to be moved without server intervention, thereby freeing up server processor cycles for other activities like application processing. Examples include a disk device backing up its data, to a tape device without server intervention, or remote device mirroring across the SAN. In addition, utilizing distributed file systems, such as IBM's Storage Tank technology, clients can directly communicate with storage devices.

SANs allow applications that move data to perform better, for example, by having the data sent directly from a source device to a target device with minimal server intervention. SANs also enable new network architectures where multiple hosts access multiple storage devices connected to the same network. SAN 10 can potentially offer the following benefits: Improvements to application availability: Storage is independent of applications and accessible through multiple data paths for better reliability, availability, and serviceability. Higher application performance: Storage processing is off-loaded from servers and moved onto a separate network. Centralized and consolidated storage: Simpler management, scalability, flexibility, and availability. Data transfer and vaulting to remote sites: Remote copy of data enabled for disaster protection and against malicious attacks. Simplified centralized management: Single image of storage media simplifies management.

Fibre Channel is an architecture upon which SAN implementations can be built, with FICON as the standard protocol for z/OS systems, and FCP as the standard protocol for open systems. However, due to costs associated with the Fibre Channel architecture, larger volumes of existing IP networks and the wider skilled manpower base familiar with IP networks, there has been an increased movement towards using TCP/IP, the networking technology of Ethernet LANs and the internet, for storage.

IP Storage

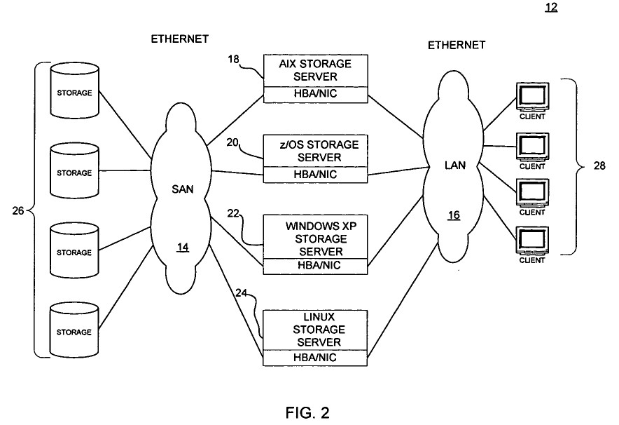

FIG. 2 illustrates an IP Storage system 12, in which SCSI over IP (iSCSI) is utilized to enable general purpose storage applications to run over TCP/IP. System 12 includes IP SAN 14 and LAN 16. IP SAN 14 includes AIX storage server 18, z/OS storage server 20, Windows XP storage server 22, and Linux storage server 24. In alternative IP storage systems, additional storage servers and operating systems (e.g., AIX, etc.) can be utilized. IP SAN 14 also includes storage subsystems 26. Lan 16 includes clients 28.

An IP SAN such as IP SAN 14 can leverage the prevailing technology of the Internet to scale from the limits of a LAN to wide area networks, thus enabling new classes of storage applications. SCSI over IP (iSCSI) enables general purpose storage applications to run over TCP/IP. Moreover, IP SAN 14 automatically benefits from new networking developments on the Internet, such as Quality of Service (QoS) and security. It is also widely anticipated that the total cost of ownership of IP SANs will be lower than Fibre Channel (FC) SANs. This is due to larger volumes of existing IP networks and the wider skilled manpower base familiar with them.

However, IP storage system 12 does face challenges, including the fact that IP networking is based on design considerations different from those of storage concepts. Thus, it is necessary to merge the two concepts and still provide the performance of a specialized storage protocol like SCSI, with block I/O direct to devices. The TCP/IP protocol is software-based and geared towards unsolicited packets, whereas storage protocols are hardware-based and use solicited packets. A storage networking protocol such as iSCSI needs to leverage the TCP/IP stack without change and still achieve high performance.

iSCSI allows SCSI block I/O protocols (commands, sequences and attributes) to be sent over a network using the popular TCP/IP protocol. This is analogous to the way SCSI commands are already mapped to Fibre Channel, parallel SCSI, and SSA media.

As explained, iSCSI needs to leverage the TCP/IP stack without change and still achieve high performance. However, TCP/IP processing presents high overhead for a host CPU. Such high overhead, that host servers performance levels can become unacceptable for block storage transport. TCP/IP offload technology in hardware has been suggested as a solution to the high TCP/IP overhead.

The processing of TCP/IP over Ethernet is traditionally accomplished by software running on the central processor, CPU or microprocessor, of the server. The CPU may or may not become burdened by the TCP/IP protocol and iSCSI processing. Numerous factors in the host and SAN environment determine whether such protocol processing will be a burden. However, reassembling out-of-order packets, resource-intensive memory copies, and interrupts can put a tremendous load on the host CPU. In high-speed networks, the CPU has to dedicate more processing to handle the network traffic than to the applications it is running.

Offload Processing

The TCP offload engine (TOE) is emerging as a static and inflexible solution to limit the processing required by CPUs for networking links. A TOE may be embedded in a network interface card, NIC, or host bus adapter, HBA.

The basic idea of a TOE is to offload protocol processing (TCP/IP, iSCSI, etc.) from the host processor to the hardware on the adapter or in the system, without regards to initial state of the host environment, nor to changes that may occur in the host or the SAN environment.

In an exemplary embodiment, the invention is an intelligent offload engine (IOE), which facilitates optimum TCP/IP and iSCSI protocol processing, the networking technology of Ethernet LANs and the Internet, for storage. This enhances the ability of having a single network for everything, including storage, data sharing, Web access, device management using SNMP, e-mail, voice and video transmission, and other uses.

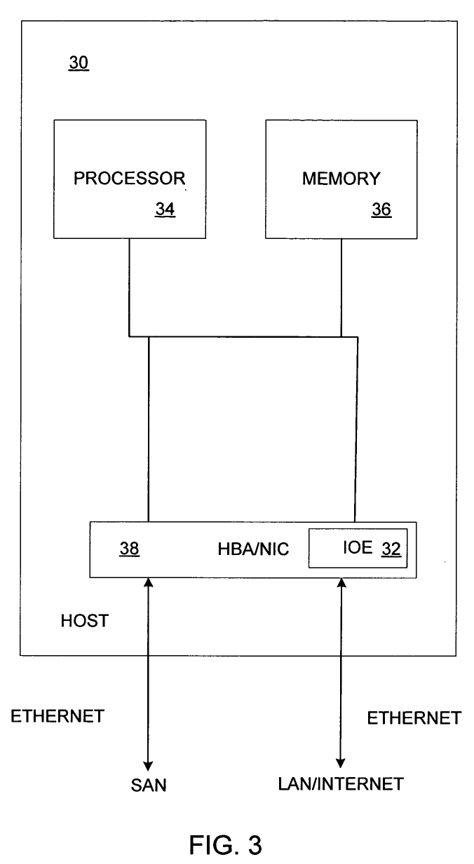

FIG. 3 illustrates a block diagram of IP storage system 10 host server 30 (e.g., z/OS storage server 20) including intelligent offload engine (IOE) 32, according to an exemplary embodiment of the invention. Host server 30 includes processor 34, memory 36 and HBA/NIC 38. IOE 32 is included within HBA/NIC 38. In the exemplary embodiment, a standard HBA/NIC 38 is modified to include IOE 32.

Details of the IOE

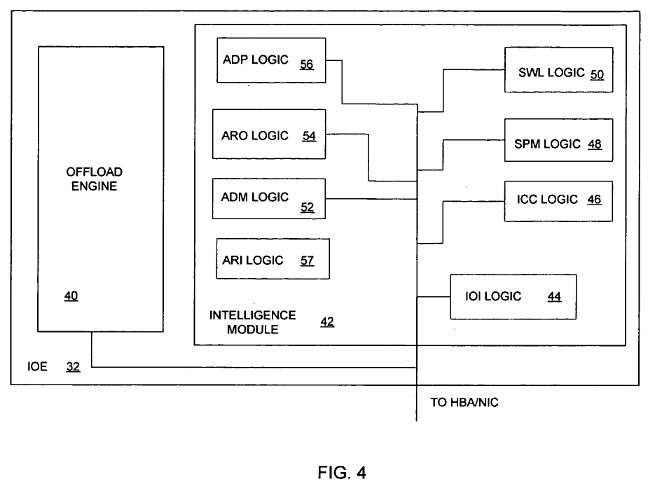

FIG. 4 is a block diagram of IOE 32, according to an exemplary embodiment of the invention. IOE 32 includes offload engine 40. Offload engine 40 performs protocol processing (e.g., TCP/IP, iSCSI, etc.) that otherwise would be performed by host server 30 processor 34. The decision and configuration process involved in determining whether or not the offload engine 40 will handle protocol processing for host server 30 is controlled by intelligent module (IM) 42. In the exemplary embodiment, IM 42 configures protocol processing between host server 30 and IOE 32, in order to improve optimization of protocol processing between processor 34 and offload engine 40.

IM 42 includes intelligent offload initiation (IOI) logic 44. IOI logic 44 is responsible for launching the decision and configuration process controlled by IM 42. Upon initial startup of HBA/NIC 38, IOI logic 44 starts up and sends a signal to initial configuration computation (ICC) logic 46 to determine and set the initial configuration for IOE 32.

In order to determine the initial configuration, ICC logic 46 needs information regarding system parameters associated with host server 30 and HBA/NIC 38. System parameters are statically analyzed to determine an optimal protocol processing configuration between host server 30 and IOE 32. ICC logic 46 contacts system parameter measurement (SPM) logic 48 and system workload (SWL) logic 50. SPM logic 48 provides ICC logic 46 with system parameters associated with the environment of host server 30 and the environment of HBA/NIC 38. System parameters collected by SPM logic 48 and SWL logic 50 include speed of the host (Sₕ), speed of the HBA/NIC (S_{hba/nic}), application work (CPU cycles) per unit of bandwidth bandwidth for a reference host (Wₐ), network processing work (CPU cycles) per unit of bandwidth for a reference host (W_{tcp/ip}), storage protocol work (CPU cycles) per unit of bandwidth for a reference host (W_{iSCSI}), bandwidth of the interconnect (e.g., GigE, FibreChannel) (Max_Bw), and the fraction of network processing work which remains as a result of offload (FR_{tcp/ip}). With regards to FR_{tcp/ip} it is determined that some network protocol functions actually get eliminated (e.g., copy) rather than just move to the IOE 32 at HBA/NIC 38.

SPM logic 48 and SWL logic 50 identify the system parameters by monitoring static host server 30 and HBA/NIC 38 system configuration parameters and run-time workload characteristics. The Sₕ, S_{hba/nic}, and Max_Bw are easy to obtain using well known techniques. A profiler can be run separately to derive Wₐ, W_{tcp/ip}, and W_{iSCSI}. Profiler such as oprofile (A system profiler for Linux. http://oprofile.sourceforge.net) and vtune (Intel. Vtune Performance Analyzers Homepage, http://developer.intel.com/software products/vtune/index.htm) can do this without imposing much overhead on host server 30 or HBA/NIC 38.

With regards to W_{tcp/ip}, it can be broken into categories, including per-transfer overhead, per-packet or per-segment overhead, and per-byte overhead.

Per-transfer overhead includes the cost for each SEND or RECEIVE operation from the TCP user. Per-transfer costs include the cost to initiate each operation (e.g., kernel system call costs). Also, per-transfer costs include the cost to notify the TCP user that it is complete. Moreover, per-transfer costs include the cost to allocate, post, and release buffers for each transfer.

Per-packet or per-segment overhead is the cost to process each network packet, segment, or frame. Per-packet or per-segment costs include the cost to execute the TCP/IP protocol code, allocate and release packet buffers (e.g., mbufs). Per-packet or per-segment costs include the cost to field HBA/NIC interrupts for packet arrival and transmit completion.

Per-byte overhead includes the cost to copy data with the end system and the cost compute checksums to detect data corruption in the system.

Thus, W_{tcp/ip}=per message work/message size+per packet work/packet size+per byte work. Similarly, W_{iSCSI} and Wₐ can be calculated. Wₐ will only have the message component for the work. There are two system parameter components that might change at run-time, they include application workload and message size (as a result of workload change) change in application workload results in a change in the number and size of the messages. Therefore, a workload change will have an impact on Wtcp cost, Wiscsi and Wa (all three costs listed above).

ICC logic 46 utilizes information collected from SPM 48 and SWL 50 to determine the ability of the host server 30 and IOE 32 to perform protocol processing. After assessing the ability of host server 30 and IOE 32 to perform protocol processing, ICC logic 46 determines an optimal protocol configuration between host server 30 and IOE 32.

In the exemplary embodiment, when determining an optimal protocol configuration, ICC logic 46 decides whether the host server 30 or the IOE 32 will handle processing of the TCP/IP protocol and whether the host server 30 or the IOE 32 will handle processing of the iSCSI protocol. The ICC logic 46 identifies the configuration choice which gives the best possible throughput. There are several possible protocol processing configurations which can be derived by ICC logic 46, including iSCSI protocol and TCP/IP protocol both being handled by host server 30, the iSCSI and TCP/IP protocol both being handled by IOE 32, and the iSCSI protocol being handled by host server 30 while the TCP/IP protocol is being handled by IOE 32.

The pseudo-code presented below provides further details of the processing which takes place at ICC logic 46. The same processing takes place at the ADM logic 52 presented below.

```
Best Configuration = Current configuration /* Current configuration = 0
for initial setup */
for ( Each protocol stack configuration)
  {
    Calculate throughput at host - Host throughput
  Calculate throughput at NIC - NIC throughput
  Current Configuration = Minimum of (Host throughput,
  NIC throughput, Max_Bw).
  /*The application throughput cannot exceed this in any event.
  In calculating the throughput in this manner we also capture the
  bottleneck point which prevents the application from getting better
  throughput.*/
  If (Current configuration > Best Configuration)
        Best Configuration = Current Configuration
  }
```

The throughputs for each configuration (in the pseudo-code) are calculated as follows:

The basis for all the formulas is the simple concept of Work/Speed=Time. This will give the time to do the total work per unit of bandwidth. Thus, the reciprocal of time will give us the throughput.
1. iSCSI+TCP/IP at host
Host throughput=1/((Wₐ/Sₕ)+((W_{iSCSI}+W_{tcp/ip})/Sₕ))
The NIC is this case will give the full network throughput, since the network adapters are designed so.
2. iSCSI+TCP/IP at NIC
Host throughput=1/(Wₐ/Sₕ)
NIC throughput=1/(((W_{iSCSI})/S_{nic})+((W_{tcp/ip}*FR_{tcp/ip})/S_{nic}))
3. iSCSI at host, TCP/IP at NIC
Host throughput=1/((Wa/Sh)+(W_{iSCSI}/Sₕ))
NIC throughput=1/((W_{tcp/ip}*FR_{tcp/ip})/S_{nic})

Upon determining the optimal protocol processing configuration, ICC logic 46 implements the configuration between host server 30 and IOE 32.

IM 42 also includes adaptive decision monitor (ADM) logic 52. ADM logic 52 is similar to ICC logic 46, except ADM logic 52 is responsible for monitoring the configuration after it has been set by ICC logic 46 to determine if changes are needed to maintain or improve optimal protocol processing between host server 30 and IOE 32. That is, after the initial configuration described above, protocol processing between host server 30 and IOE 32 is continuously monitored for changing workload characteristics. Thus, the configuration is further tuned to best suit the workload and system characteristics.

ADM logic 52 utilizes both SPM logic 48 and SWL logic 50 in determining changes are needed. System parameter information provided by SPM logic 48 and SWL logic 50 to ADM logic 52 is the same as described above with regards to those system parameters provided to ICC logic 46. The ADM logic 52, similar to ICC logic 46, is responsible for identifying the configuration choice which provides the best possible throughput. The actual gain obtained form having a different protocol configuration between host server 30 and IOE 32, if the current configuration is not the best choice.

If ADM logic 52 determines that changes are needed it contacts adaptive reconfiguration option (ARO) logic 54, and instructs ARO logic 54 to identify possible reconfiguration scenarios in light of ADM logic 52 determination that changes are needed.

ARO logic 54 provides the identified possible reconfiguration scenarios to adaptive decision presentation (ADP) logic 56. Moreover, ARO logic 54 can identify factors limiting the ability to improve the current protocol processing configuration between host server 30 and IOE 32. ADP logic 56 presents the identified possible reconfiguration scenarios (and any identified limiting factors) to a system administrator. The system administrator can determine whether to implement one of the identified reconfiguration scenarios. In an alternative embodiment, instead of presenting the possible reconfiguration scenarios to a system administrator, autonomic logic is included to determine whether to implement one of the possible reconfiguration scenarios, and which one to implement.

If either the system administrator or autonomic logic indicates that an identified reconfiguration scenario is to be implemented, this indication is provided to the adaptive reconfiguration implementation (ARI) logic 57. Similar to ICC logic 46, implements the protocol processing configuration between host server 30 and IOE 32.

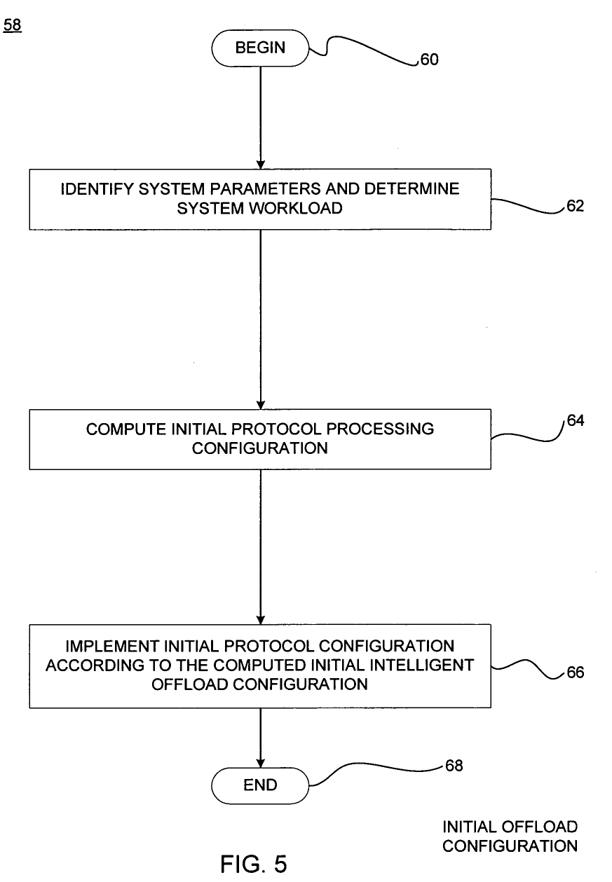

FIG. 5 illustrates a method 58 of determining and configuring an initial protocol processing configuration between host server 30 and IOE 32, according to an exemplary embodiment of the invention. At block 60, method 58 begins.

At block 62, system parameters are identified and the workload of server 30 is determined.

At block 64, the initial protocol processing configuration is computed.

At block 66, the initial protocol processing configuration computed at block 64 is implemented.

At block 68, method 58 ends.

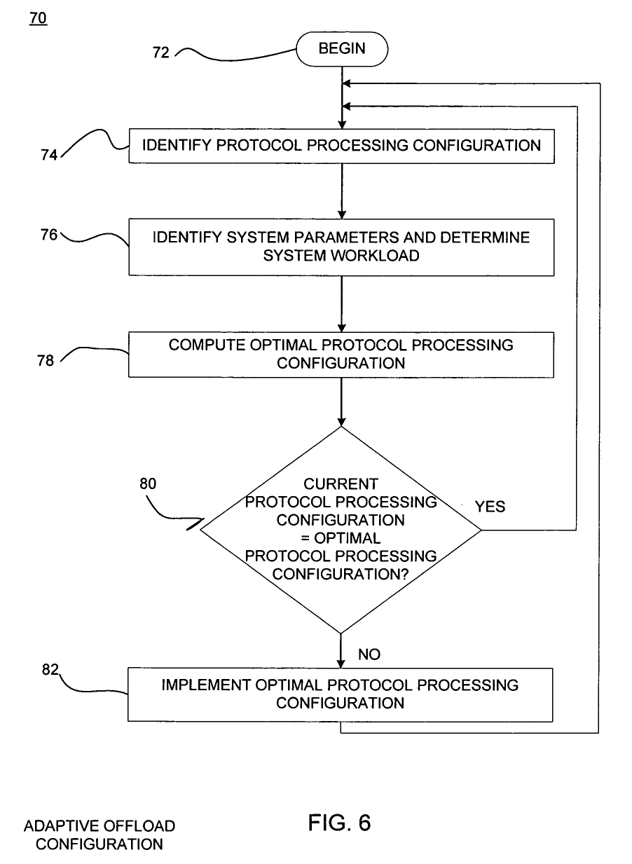

FIG. 6 illustrates a method 70 of adaptively configuring the protocol processing configuration between host server 30 and IOE 32, according to an exemplary embodiment of the invention. At block 72, method 70 begins.

At block 74, the current protocol processing configuration is identified.

At block 76, system parameters and workload are determined.

At block 78, in light of the determined system parameters and workload, the optimal protocol processing configuration is computed.

At block 80, a determination is made as to whether the current protocol processing configuration equals the optimal protocol processing configuration. If yes, then method 70 loops back to block 74. If no, then at block 82, the optimal protocol processing configuration computed at block 78 is implemented.

Protocol Processing in Configured System

When data is leaving host server 30 in to the network (send path) the SCSI layer makes a call to the SCSI port driver, which makes a call to the mini-port driver. The mini-port driver code has been structured so that it has two paths. Configuration code executed during the configuration time sets some configuration parameter values which are used in the mini-port driver code to choose between the following paths:

Path 1: Consists of iSCSI software driver code. The software driver code, in turn, contains TCP/IP socket calls which utilize the software TCP/IP stack at host server 30.

Path 2: The iSCSI software driver code makes calls to the iSCSI HBA/NIC provided I/O APIs which, in turn, invoke the iSCSI code (and TCP/IP code) on the HBA/NIC 38.

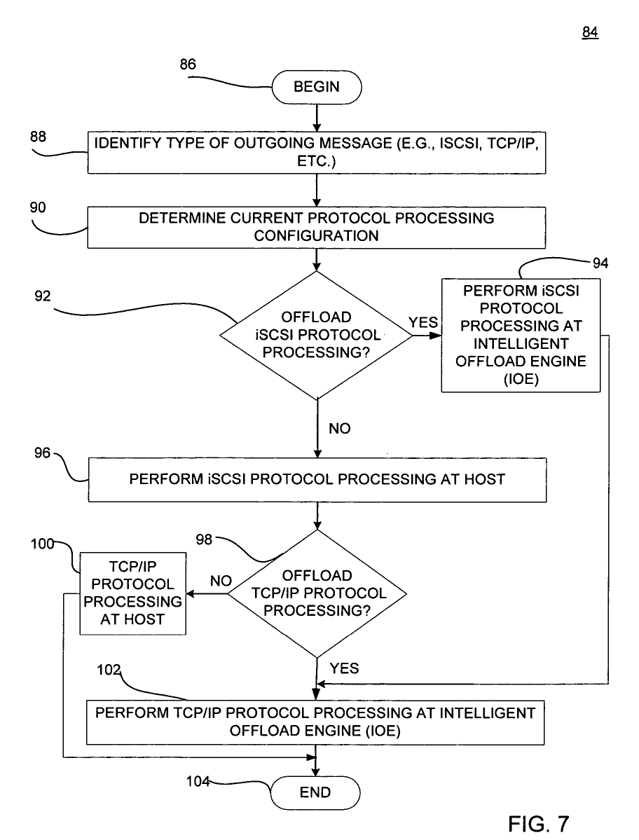

FIG. 7 illustrates a method 84 of handling protocol processing for messages leaving a host (e.g., host server 30) in which IOE 32 is utilized, according to an exemplary embodiment of the invention.

At block 86, method 84 begins.

At block 88, the type of message is identified. Here we are concerned with SCSI over IP (iSCSI) message directed to system 12 storage subsystem 26 over IP SAN 14.

At block 90, a determination is made as to what the current protocol processing configuration is between host server 30 and IOE 32. The initial configuration and adaptive configuration were described above. The protocol processing configuration provides information with regards to whether host server 30 or IOE 32 will perform protocol processing (e.g., iSCSI, TCP/IP).

At block 92, a determination is made as to whether iSCSI protocol processing is to be offloaded to IOE 32. If yes, then at block 94, iSCSI protocol processing will be performed at IOE 32 for the message in question. Importantly, if iSCSI processing for a message in the send path from host server 30 is to be performed at IOE 32, then the necessary TCP/IP protocol processing for the same message will also be performed at IOE 32 (see block 102).

Returning to block 92. If no, then at block 96 iSCSI protocol processing is performed at host server 30.

At block 98, a determination is made as to whether TCP/IP protocol processing will be offloaded. If no, then at block 100, TCP/IP protocol processing is handled by host server 30. If yes, then at block 102, TCP/IP protocol processing is performed at IOE 32.

At block 104, method 84 ends.

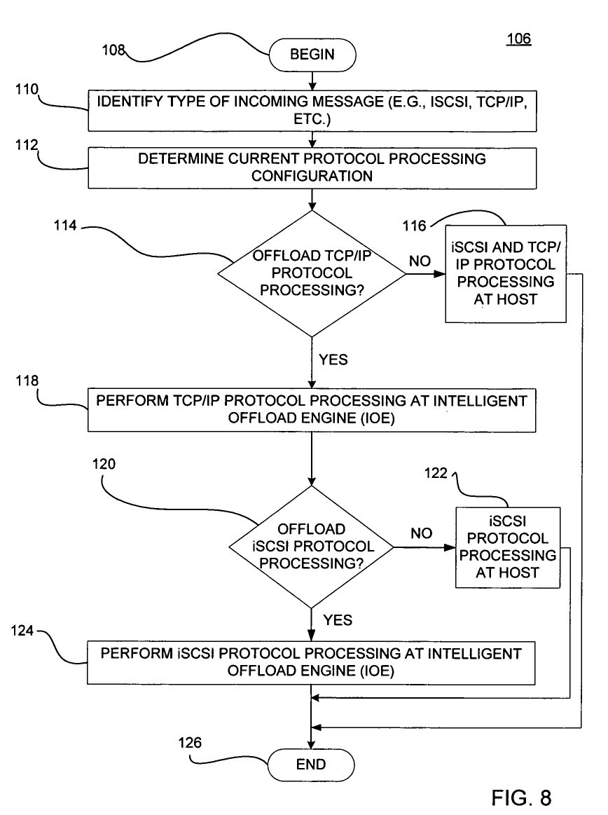

FIG. 8 illustrates a method 106 of handling protocol processing for messages entering host server 30 via HBA/NIC 38, in which IOE 32 is utilized, according to an exemplary embodiment of the invention.

At block 108 method 106 begins.

At block 110, the type of message is identified. Here we are concerned with SCSI over IP (iSCSI) message directed to system 12 storage subsystem 26 over IP SAN 14.

At block 112, a determination is made as to what the current protocol processing configuration is between host server 30 and IOE 32. The initial configuration and adaptive configuration were described above. The protocol processing configuration provides information with regards to whether host server 30 or IOE 32 will perform protocol processing (e.g., iSCSI, TCP/IP).

At block 114, a determination is made as to whether TCP/IP protocol processing is to be offloaded to IOE 32. If no, then at block 116, TCP/IP and iSCSI protocol processing will be performed at host server 30. In order for iSCSI protocol processing to take place, the TCP/IP message in which the iSCSI message is encapsulated, must be removed. Hence, if the TCP/IP message is bypassing IOE 32 so that TCP/IP protocol processing can take place at host server 30, then clearly the iSCSI protocol processing associated with the same message will also take place at host server 30.

Returning to block 114. If yes, then at block 118, TCP/IP protocol processing is performed at IOE 32.

At block 120, a determination is made as to whether iSCSI protocol processing will be offloaded. If no, then at block 122, iSCSI protocol processing is handled by host server 30. If yes, then at block 124, iSCSI protocol processing is performed at IOE 32.

At block 126, method 84 ends.

Thus, a method and program product to provide an intelligent protocol processing configuration between a server and its HBA/NIC have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method of configuring protocol processing between a host and an intelligent offload engine in order to improve optimization of protocol processing, comprising:
evaluating the host and the host environment to identify system parameters associated with the host and a host bus adapter card, wherein the intelligent offload engine exists at the host bus adapter card;
determining the ability of the host and the intelligent offload engine to perform protocol processing according to the identified system parameters;
determining an optimal protocol processing configuration between the host and the intelligent offload engine, according to the determined ability of the host to perform protocol processing and the intelligent offload engine ability to perform protocol processing; and
implementing the determined optimal protocol processing configuration.

2. The method of claim 1 wherein the configuring of protocol processing between the host and the intelligent offload engine is done on initial configuration of the intelligent offload engine.

3. The method of claim 2 wherein the system parameters identified during the evaluating of the host and the host environment comprise host CPU speed, HBA speed, network bandwidth, and pathlength change by offloading protocol processing from the host to the HBA.

4. The method of claim 1 wherein the configuring of protocol processing between the host and the intelligent offload engine occurs during run-time.

5. The method of claim 4 wherein the configuring during run-time provides for adaptive configuration of the protocol processing between the host and the offload intelligent engine as a result of system parameter changes.

6. The method of claim 5 wherein the system parameters identified during the evaluating of the host and the host environment comprise the speed of the host, the speed of the host bus adapter card, application work per unit of bandwidth for the host, TCP/IP protocol processing work per unit of bandwidth for the host, iSCSI protocol processing per unit of bandwidth of the host, bandwidth of the interconnect, and the amount of TCP/IP processing that would remain if TCP/IP protocol processing were handled by an offload engine at the host bus adapter card.

7. The method of claim 1 wherein the interconnect comprises Ethernet.

8. The method of claim 1 wherein determining the ability of the host to perform protocol processing according to the identified system parameters, comprises analyzing the identified system parameters to determine the host's CPU utilization and the amount of CPU processing power available for protocol processing.

9. The method of claim 1 wherein determining the optimal protocol offload configuration comprises determining the most efficient distribution of the protocol processing between the host and the offload engine in response to the host and the host offload engine's determined ability to perform protocol processing.

10. The method of claim 9 wherein the protocols to be processed comprise TCP/IP and iSCSI.

11. The method of claim 9 wherein determining the distribution of protocol processing comprises deciding whether the host stack or the host bus adapter stack will handle processing of the TCP/IP protocol and whether the host stack or the host bus adapter stack will handle processing of the iSCSI stack.

12. The method of claim 11 wherein the distribution of the protocol processing, comprises the iSCSI protocol and TCP/IP protocol both being handled by the host stack, the iSCSI and TCP/IP protocol both being handled by the host bus adapter stack, or the iSCSI protocol being handled by the host stack and the TCP/IP protocol being handled by the host bus adapter stack.

13. An intelligent offload engine comprising a machine-readable medium including machine-executable instructions therein for configuring protocol processing responsibility between a host and the intelligent offload engine in order to improve the efficiency of the protocol processing, comprising:
evaluating the host and the host environment to identify system parameters associated with the host and a host bus adapter card (HBA), wherein the intelligent offload engine exists at the HBA card;
determining the ability of the host and the intelligent offload engine to perform protocol processing according to the identified system parameters;
determining an optimal protocol processing configuration between the host and the intelligent offload engine, according to the determined ability of the host to perform protocol processing and the intelligent offload engine ability to perform protocol processing; and
implementing the determined optimal protocol processing configuration.

14. The intelligent offload engine of claim 13 wherein the intelligent offload engine in is an ASIC which may be incorporated into an existing HBA.

15. The intelligent offload engine of claim 14 wherein the HBA comprises an HBA or a network interface card (NIC).

16. The intelligent offload engine of claim 13 wherein the intelligent offload engine performs an initial configuration of protocol processing between the host and the intelligent offload engine.

17. The intelligent offload engine of claim 16 wherein the system parameters identified through the evaluating of the host and the host environment, during the initial configuration, comprises host CPU speed, HBA speed, network bandwidth, and pathlength change by offload.

18. The intelligent offload engine of claim 13 wherein the intelligent offload engine performs dynamic configuration of protocol processing between the host and the intelligent offload engine during run-time.

19. The intelligent offload engine of claim 18 wherein the dynamic configuration of protocol processing during run-time is in response to changes associated with the system parameters identified through the evaluating of the host and the host environment, wherein the changes associated with the identified system parameters have occurred since the initial configuration of protocol processing, or since the previous dynamic configuration of protocol processing.

20. The intelligent offload engine of claim 19 wherein the system parameters identified through the evaluating of the host and the host environment, during the dynamic configuration, comprise the speed of the host bus adapter card, application work per unit of bandwidth for the host, TCP/IP protocol processing work per unit of bandwidth for the host, iSCSI protocol processing per unit of bandwidth of the host, bandwidth of the interconnect, and the amount of TCP/IP processing that would remain if TCP/IP protocol processing were handled by an offload engine at the host bus adapter card.

21. The intelligent offload engine of claim 20 wherein the interconnect comprises Ethernet.

22. The intelligent offload engine of claim 13 wherein determining the ability of the host to perform protocol processing according to the identified system parameters, comprises analyzing the identified system parameters to determine the host's CPU utilization and the amount of CPU processing power available for protocol processing.

23. The intelligent offload engine of claim 13 wherein determining the optimal protocol processing configuration comprises determining the distribution of the protocol processing between the host and the offload engine in order to provide improved protocol processing efficiency,
whereby a static protocol processing implementation only provides for protocol processing to occur at either the host or an offload engine without balancing consideration to the optimal protocol offload configuration.

24. The intelligent offload engine of claim 23 wherein the protocols to be processed comprise TCP/IP and iSCSI.

25. The intelligent offload engine of claim 23 wherein the determining of the distribution of protocol processing, comprises deciding whether the host stack or the host bus adapter stack will handle processing of the TCP/IP protocol and whether the host stack or the host bus adapter stack will handle processing of the iSCSI stack.

26. The intelligent offload engine of claim 25 wherein the distribution of the protocol processing, comprises the iSCSI protocol and TCP/IP protocol both being handled by the host stack, the iSCSI and TCP/IP protocol both being handled by the host bus adapter stack, or the iSCSI protocol being handled by the host stack and the TCP/IP protocol being handled by the host bus adapter stack.

27. A system to provide configuration of protocol processing between a host and an intelligent offload engine in order to improve optimization of protocol processing, comprising:
a means for evaluating the host and the host environment to identify system parameters associated with the host and a host bus adapter card, wherein the intelligent offload engine exists at the host bus adapter card;
a means for determining the ability of the host and the intelligent offload engine to perform protocol processing according to the identified system parameters;
a means for determining an optimal protocol processing configuration between the host and the intelligent offload engine, according to the determined ability of the host to perform protocol processing and the intelligent offload engine ability to perform protocol processing; and
a means for implementing the determined optimal protocol processing configuration.
